(19) United States
(12) Patent Application Publication
(10) Pub. No.: US 2012/0005941 A1
(43) Pub. Date: Jan. 12, 2012

(54) FISHING POLE STAND

(76) Inventor: Kung Mi Lan, Pingtung City (TW)

(21) Appl. No.: 12/832,043

(22) Filed: Jul. 7, 2010

(51) Int. Cl. A01K 97/04; A01K 97/10

(52) U.S. Cl. 43/21.2; 43/55

(57) ABSTRACT

A fishing rod holder includes a base plate and a fishing ice box. The base plate is provided with at least one rod holding portion that is erectable or foldable. The rear edge of the base plate is connected by hinges to the bottom of one side surface of the fishing ice box, so that the base plate can be folded to abut against the side surface of the fishing ice box. Therefore, the present invention provides a fishing rod holder that includes a fishing ice box attached to at least one rod holding portion. Further, the fishing ice box is also used for supporting the fishing rod, so that the present invention can be folded for storage and ease of carrying.

### BACKGROUND OF THE INVENTION

1. Field of the Invention

The present invention relates to a fishing pole stand, and in particular to a fishing rod holder that is attachable to a fishing ice box for supporting the fishing rod. Further, the fishing rod holder of the present invention can be folded for storage and is easy to carry.

2. Description of the Prior Art

When fishing, a fisherman often uses a fishing rod holder to support the fishing rod and while waiting for a fish strike, thereby protecting his hands from getting hurt from pain resulting from holding the fishing rod for long periods of time. Currently, there are many kinds of fishing rod holders that are used for river fishing, pond fishing, beach fishing, rock fishing, breakwater fishing, concrete-shore fishing and the like. A skilled fisherman often chooses the most suitable fishing rod holder depending on the location at which he is fishing because each kind of fishing rod holder has a unique characteristic. For example, the fishing rod holders used for river fishing, pond fishing or beach fishing are directly inserted into the ground for supporting the fishing rod, while the fishing rod holders used for breakwater fishing or concrete-shore fishing are fixed by screws to a fixing element that is mounted to the concrete by drilling a hole in the concrete. As a result, one who enjoys fishing at different sites has to buy different fishing rod holders, which leads to high expenses related to fishing tackle as well as to trouble associated with carrying the various fishing rod holders around. On the other hand, in breakwater fishing or concrete-shore fishing, the concrete has to be drilled in advance so as to anchor a fixing element to which the fishing rod holder is secured, which is inconvenient for the fisherman and inevitably damages the concrete.

### SUMMARY OF THE INVENTION

A primary object of the present invention is to provide a fishing rod holder in order to solve the problems associated with the prior art. The fishing rod holder of the present invention is attachable to a fishing ice box for supporting the fishing rod.

In order to achieve the above object, the present invention provides a fishing rod holder, which includes a base plate and a fishing ice box, the base plate being provided with at least one rod holding portion that is erectable and foldable. The base plate is provided with at least one storage trough matching the profile of the rod holding portion as well as a left positioning hole and a right positioning hole. The rod holding portion has a left side bar and a right side bar. One end of each of the left side bar and the right side bar are respectively provided with a rotating shaft and are rotatably mounted in the storage trough of the base plate by way of a fixing element. The other ends of the left side bar and the right side bar are rotatably provided with a first restricting bracket by using respective pivotal shafts. The left side bar and the right side bar are rotatably provided with a left supporting rod and a right supporting rod by using the pivot shaft. The middle sections of the left side bar and the right side bar are rotatably provided with a second restricting bracket by providing each with another respective pivot shaft. The fishing ice box is a box for holding ice.

With the above structure, a rear edge of the base plate is connected by hinges to the bottom of one side surface of the fishing ice box, so that the base plate can be folded along the hinges to abut against the side surface of the fishing ice box. Therefore, the present invention provides a fishing rod holder including a fishing ice box attached by at least one rod holding portion Further, the fishing ice box is also used for supporting the fishing rod, so that the present invention can be folded for storage and is easy carry.

### BRIEF DESCRIPTION OF THE DRAWINGS

FIG. 1 is a perspective view of the present invention;

FIG. 2 is a side view of the present invention illustrating a fishing rod inserted between a first restricting bracket and a second restricting bracket;

FIG. 3 is a schematic view of the present invention illustrating rod holding portions folded into storage troughs; and

FIG. 4 is a schematic view of the present invention illustrating a base plate and rod holding portions folded to abut against one side surface of a fishing ice box.

### DETAILED DESCRIPTION OF THE INVENTION

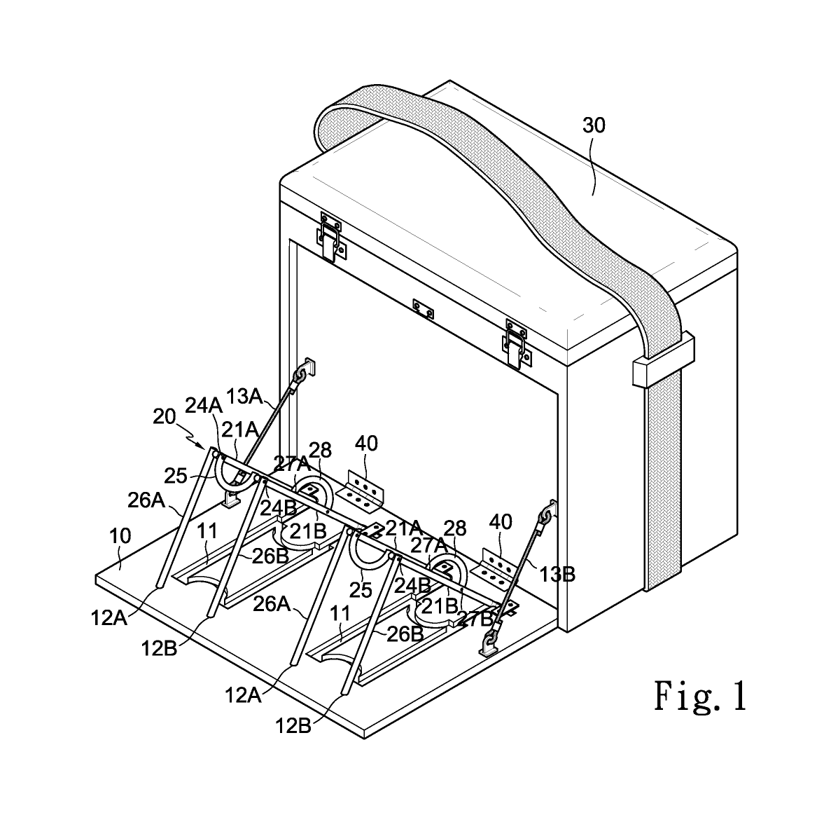

The technical contents and structure of the present invention will be described in more detail with reference to a preferred embodiment shown in FIGS. 1 to 4.

Please refer to FIG. 1. The present invention provides a fishing rod holder comprising a base plate 10 and a fishing ice box 30. The base plate 10 is provided with at least one rod holding portion 20 that is erectable or foldable.

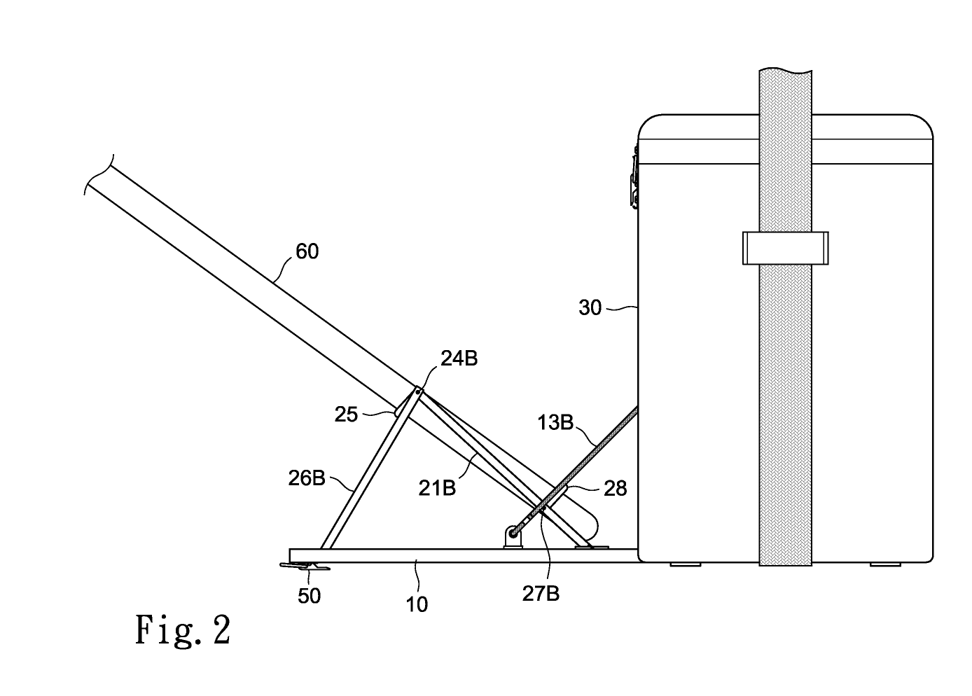

Please also refer to FIGS. 2 to 4. The base plate 10 is provided with at least one storage trough 11 that matches the profile of the rod holding portion 20 as well as a left positioning hole 12A and a right positioning hole 12B.

The rod holding portion 20 has a left side bar 21A and a right side bar 21B. One end of each of the left side bar 21A and the right side bar 21B are respectively formed with a rotating shaft 22A and 22B and are rotatably set within the storage trough 11 of the base plate 10 by way of a fixing element 23A and 23B. The other ends of the left side bar 21A and the right side bar 21B are rotatably provided with a first restricting bracket 25 by using a pivotal shaft 24A, 24B respectively. The left side bar 21A and the right side bar 21B are rotatably provided with a left supporting rod 26A and a right supporting rod 26B by the pivot shaft 24A, 24B respectively. The middle sections of the left side bar 21A and the right side bar 21B are rotatably provided with a second restricting bracket 28 by using another pivot shaft 27A, 27B respectively. Preferably, each of the first restricting bracket 25 and the second restricting bracket 28 is in the form of a semi-circular bracket.

The fishing ice box 30 is a box that holds ice to keep fish fresh.

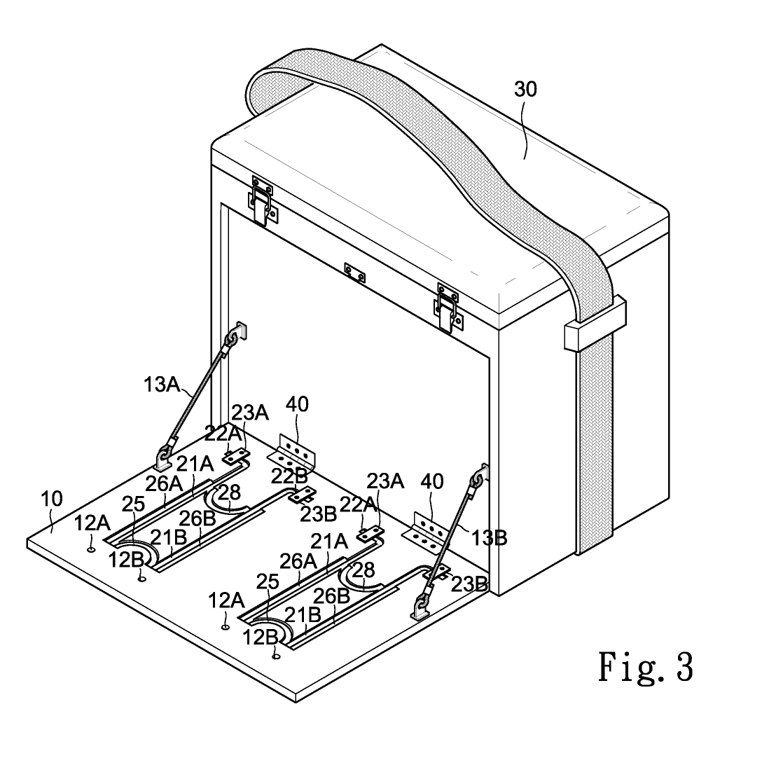

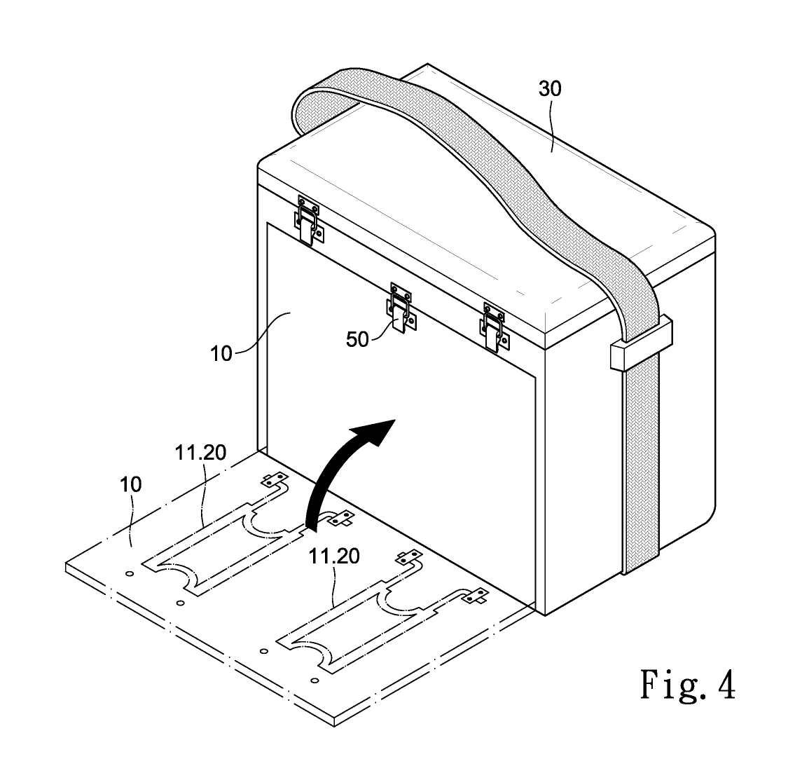

With the above structure, the rear edge of the base plate 10 can be connected by hinges 40 to the bottom of one side surface of the fishing ice box 30 (FIGS. 1 and 3), so that the base plate 10 can be lifted up or put down by means of the hinges 40 as shown in FIGS. 1 and 4. In a preferred embodiment of the present invention, an angle-restricting element 13A is provided between the left side of the base plate 10 and the fishing ice box 30, while an angle-restricting element 13B is provided between the right side of the base plate 10 and the fishing ice box 30. Thus, when in use, a fixing buckle 50 is unfastened, whereby the base plate 10 can be put down into a horizontal position (FIG. 3). Then, the rod holding portion 20 is erected (FIGS. 1 and 2). The bottom ends of the left supporting rod 26A and right supporting rod 26B are inserted into the left positioning hole 12A and the right positioning hole 12B of the base plate 10 respectively. The first restricting bracket 25 rotates downwardly using the pivot shafts 24A and 24B as a center of rotation, so that the opening of the semi-circular first restricting bracket 25 faces upward. Further, the second restricting bracket 28 rotates upwardly using the pivot shafts 27A and 27B as a center of rotation, so that the opening of the semi-circular second restricting bracket 28 faces downward. Finally, a fishing rod 60 is inserted between the first restricting bracket 25 and the second restricting bracket 28 (as shown in FIG. 2) for supporting the fishing rod 60. When the fishing rod holder of the present invention is not in use, as shown in FIG. 3, the rod holding portion 20 can be folded into the storage trough 11 of the base plate 10. Then, as shown in FIG. 4, the base plate 10 is folded to abut against one side surface of the fishing ice box 30 and fastened with the fixing buckle 50. In this way, the rod holding portion 20 can be stored on the side surface of the fishing ice box 30, so that it is convenient for the user to carry the fishing ice box 30 together with the rod holding portion 20.

The above disclosed embodiment is merely a preferred embodiment of the present invention. Various equivalent variations and modifications may be designed as known to those skilled in the art in view of the teachings of the present invention. Thus, all such variations and equivalent modifications are also embraced within the scope of the invention as defined in the appended claims.

What is claimed is:

1. A fishing rod holder, including a base plate and a fishing ice box, the base plate being provided with at least one rod holding portion that is erectable and foldable;
wherein the base plate is provided with at least one storage trough corresponding to the profile of the rod holding portion as well as a left positioning hole and a right positioning hole;
the rod holding portion having a left side bar and a right side bar, one end of the left side bar and the right side bar respectively comprising a rotating shaft and rotatably positionable into the storage trough of the base plate by way of a fixing element, the other end of the left side bar and the right side bar each comprising a rotatable first restricting bracket having a respective pivotal shaft, the left side bar and the right side bar rotatably provided with a left supporting rod and a right supporting rod by using the pivot shaft, the middle sections of the left side bar and the right side bar rotatably provided with a second restricting bracket by using another respective pivot shaft; and
the fishing ice box being a cooler for receiving ice;
whereby, a rear edge of the base plate is connected by hinges to the bottom of one side surface of the fishing ice box, so that the base plate folds to abut against the side surface of the fishing ice box.

2. The fishing rod holder according to claim 1, wherein each of the first restricting bracket and the second restricting bracket is formed into a semi-circular bracket.

3. The fishing rod holder according to claim 1, wherein an angle restricting element is provided between each side of the base plate and the fishing ice box.
